(19) United States
(12) Patent Application Publication
(10) Pub. No.: US 2018/0227923 A1
(43) Pub. Date: Aug. 9, 2018

(54) POWER INFORMATION INDICATION METHOD, POWER INFORMATION ACQUISITION METHOD, BASE STATION, AND USER EQUIPMENT

(71) Applicant: SHARP KABUSHIKI KAISHA, Sakai City, Osaka (JP)

(72) Inventors: MENG ZHANG, Shanghai (CN); QI JIANG, Shanghai (CN); RENMAO LIU, Shanghai (CN)

(73) Assignee: SHARP KABUSHIKI KAISHA

(21) Appl. No.: 15/749,863

(22) PCT Filed: Aug. 1, 2016
(86) PCT No.: PCT/CN2016/092686

§ 371 Date: Feb. 2, 2018

(30) Foreign Application Priority Data
Aug. 5, 2015 (CN) 201510474612.9

(51) Int. Cl. H04W 72/04; H04W 4/06; H04W 72/00

(52) U.S. Cl. CPC H04W 72/0473; H04W 88/023; H04W 72/005; H04W 4/06

(57) ABSTRACT

The present application discloses a power information indication method executed by a base station, and a corresponding base station. The method comprises: including power information of a Basic Physical Multicast Channel (B-PMCH) and an Enhanced Physical Multicast Channel (E-PMCH) in a Radio Resource Control (RRC) signaling or a System Information Block (SIB13), wherein the E-PMCH is superposed with the B-PMCH by adopting Multi-user Superposition Transmission (MUST) technology; and sending the RRC signaling or the SIB13 to a user equipment. The present application further discloses a power information acquisition method executed by a user equipment, and a corresponding user equipment.

### TECHNICAL FIELD

The present invention relates to the technical field of wireless communication. More particularly, the present invention relates to a power information indication method executed by a base station, a power information acquisition method executed by a user equipment, and a corresponding base station and user equipment.

### BACKGROUND

Modern wireless mobile communication systems present two significant characteristics. One is high-speed broadband, for example, the fourth generation wireless mobile communication system has a bandwidth of up to 100 MHz and a downlink speed of up to 1 Gbps. The other characteristic is mobile interconnection, which promotes emerging services, such as WAP, mobile phone video-on-demand, online navigation and the like. These two characteristics propose higher requirements for wireless mobile communication technology. Such requirements mainly include: ultrahigh-speed wireless transmission, inter-region interference suppression, mobile reliable signal transmission, distributed/centralized signal processing and the like. To satisfy the development requirements above, in a future, more enhanced Fourth Generation (4G) or Fifth Generation (5G) wireless mobile communication system, various corresponding key technologies will begin to be proposed and demonstrated, arousing the attention of researchers in the field. In October 2007, the International Telecommunication Union (ITU) approved the Worldwide Interoperability for Microwave Access (WiMAX) as the fourth third generation (3G) system standard. This event which occurred at the end of the 3G era is actually a preview of the 4G standard battle. In fact, in response to the challenge of streams of wireless Internet protocol (IP) technologies represented by Wireless Local Area Network (WLAN) and WiMax, since 2005 the 3rd Generation Partnership Project (3GPP) organization has embarked on a completely new system upgrade, i.e., standardization of Long Term Evolution (LTE). This is a quasi-fourth-generation system based on Orthogonal Frequency Division Multiplexing (OFDM) which was first released in early 2009 and started to be commercially available globally in 2010. Meanwhile, the 3GPP organization has launched the standardization of the Fourth Generation (4G) wireless mobile communication system in the first half of 2008. This system is called a Long Term Evolution Advanced (LTE-A) system. The key standardized document for the physical layer process of the system was completed in early 2011. In November 2011, the ITU organization officially announced in Chongqing, China that LTE-A systems and WiMax systems are two official standards for 4G systems. At present, the commercial process of LTE-A systems is being gradually expanded worldwide.

According to the challenges in the next decade, the following development needs for the enhanced fourth generation wireless mobile communication system are required:
a higher wireless broadband rate, with a focus on optimizing a localized cell hot area;
further improving the user experience, with a particular need to optimize communication services in the border area of a cell;
a need to continue studying new technology capable of improving the utilization efficiency of a spectrum, considering that an available spectrum cannot be expanded 1000 times;
high frequency spectra (5 GHz or higher) must be put into use to obtain larger communication bandwidths;
collaborative work of existing networks (2G/3G/4G, WLAN, WiMax, etc.) to share data traffic;
dedicated optimization for different businesses, applications, and services;
strengthening the system's ability to support large-scale machine communication;
flexible, intelligent and inexpensive network planning and network distribution;
designing a solution to save network power consumption and user equipment battery consumption.

In the conventional 3GPP LTE system, multiple pieces of user data can be transmitted over a single data stream, which is commonly referred to as Multi-user (MU) transmission technology. However, the traditional MU technology can obtain better performance only when the user's channels are as orthogonal as possible, which limits the flexibility of user scheduling to a certain extent. To this end, the 3GPP RAN #67 plenary discussed a new research topic, that is, the study of Multi-user Superposition Transmission (MUST), the main purpose of which is to study the function of transmitting multiple pieces of user information through single-stream data in an overlapping and superimposed manner by adjusting the power of multiple user-modulated signals. Compared with the traditional MU technology, the MUST technology does not require orthogonality between channels from the user to the base station. Therefore, with the use of the MUST technology, the base station can schedule users more flexibly. At present, the 3GPP may also use the MUST technology in a Multimedia Broadcast Multicast System (MBMS). On the basis of a Basic Enhanced Physical Multicase Channel (B-PMCH), the MUST technology is used to superpose an enhanced PMCH (E-PMCH) to achieve the goal of transmitting multiple PMCHs simultaneously.

However, for PMCH transmission using the MUST technology, the traditional configuration signaling related to PMCH transmission may encounter the following problem:
power allocation information of a B-PMCH and an E-PMCH cannot be indicated and acquired.

Therefore, configuration signaling related to the PMCH (e.g., Radio Resource Control (RRC) signaling) in the MUST mode needs to be redesigned.

### SUMMARY

In view of the above problem, the present invention proposes a novel power information indication and acquisition scheme to support PMCH transmission that uses the MUST technology.

According to a first aspect of the present invention, a power information indication method executed by a base station is provided. The method comprises: including power information of a Basic-Physical layer Multicast Channel (B-PMCH) and an Enhanced-Physical layer Multicast Channel (E-PMCH) in RRC signaling or a System Information Block (SIB13), wherein the E-PMCH is superposed with the B-PMCH by adopting MUST technology; and sending the RRC signaling or the SIB13 to a user equipment.

According to a second aspect of the present invention, a base station is provided. The base station comprises: a signaling processing unit, used to include power information of a B-PMCH and an E-PMCH in RRC signaling or a SIB13, wherein the E-PMCH is superposed with the B-PMCH by adopting MUST technology; and a transceiver, used to send the RRC signaling or the SIB13 to a user equipment.

According to a third aspect of the present invention, a power information acquisition method executed by a user equipment is provided. The method comprises: receiving RRC signaling or a SIB13 including power information of a B-PMCH and an E-PMCH from a base station, wherein the E-PMCH is superposed with the B-PMCH by adopting MUST technology; and extracting the power information of the B-PMCH and the E-PMCH from the received RRC signaling or SIB13.

According to a fourth aspect of the present invention, a user equipment is provided. The user equipment comprises: a transceiver, used to receive RRC signaling or a SIB13 including power information of a B-PMCH and an E-PMCH from a base station, wherein the E-PMCH is superposed with the B-PMCH by adopting MUST technology, and a signaling processing unit, used to extract the power information of the B-PMCH and the E-PMCH from the received RRC signaling or SIB13.

In the above first, second, third and fourth aspects, the power information may include one or more of the following items indicated by an information element (power-indicator-r13):

a ratio of Energy Per Resource Element (EPRE) of the B-PMCH to EPRE of a Reference Signal (RS) of an MBMS;
a ratio of EPRE of the E-PMCH to the EPRE of the RS of the MBMS;
a ratio of the EPRE of the B-PMCH to EPRE of an Enhanced-Reference Signal (E-RS) of the MBMS;
a ratio of the EPRE of the E-PMCH to the EPRE of the E-RS of the MBMS;
a ratio of the EPRE of the B-PMCH to the EPRE of the E-PMCH;
a ratio of the EPRE of the E-PMCH to the EPRE of the B-PMCH;
a ratio of EPRE of an RE for transmitting a Multicast Control Channel (MCCH) in the B-PMCH to the EPRE of the RS of the MBMS;
a ratio of EPRE of an RE for transmitting the MCCH in the E-PMCH to the EPRE of the RS of the MBMS;
a ratio of the EPRE of the RE for transmitting the MCCH in the B-PMCH to the EPRE of the E-RS of the MBMS;
a ratio of the EPRE of the RE for transmitting the MCCH in the E-PMCH to the EPRE of the E-RS of the MBMS;
a ratio of EPRE of an RE for transmitting a Multicast Traffic Channel (MTCH) in the B-PMCH to the EPRE of the RS of the MBMS;
a ratio of EPRE of an RE for transmitting the MTCH in the E-PMCH to the EPRE of the RS of the MBMS;
a ratio of the EPRE of the RE for transmitting the MTCH in the B-PMCH to the EPRE of the E-RS of the MBMS;
a ratio of EPRE of an RE for transmitting the MTCH in the E-PMCH to the EPRE of the E-RS of the MBMS;
a ratio of power of the B-PMCH to the sum of power of the B-PMCH and the E-PMCH;
a ratio of power of the E-PMCH to the sum of the power of the B-PMCH and the E-PMCH;
a ratio of the power of the B-PMCH to maximum transmit power; and
a ratio of the power of the E-PMCH to the maximum transmit power.

Alternatively, the ratios can be expressed in decibel (dB).

In the above first, second, third and fourth aspects, the power information may comprise a combination of ratios of the power of the B-PMCH and the power of the E-PMCH, indicated by an information element (power-set-indicator-r13).

### DESCRIPTION OF THE DRAWINGS

The above and other features of the present invention will be more apparent from the following detailed description taken in conjunction with the drawings, in which:

FIG. 1 is a flowchart illustrating a power information indication method executed by a base station according to an embodiment of the present invention;

FIG. 2 is a flowchart illustrating a power information acquisition method executed by a user equipment according to an embodiment of the present invention;

FIG. 3 is a sequence diagram illustrating respective processing of and signaling interaction between a base station and a user equipment according to an embodiment of the present invention;

FIG. 4 is a structural block diagram illustrating a base station according to an embodiment of the present invention; and

FIG. 5 is a structural block diagram illustrating a user equipment according to an embodiment of the present invention.

### DESCRIPTION OF THE EMBODIMENTS

The proposed power information indication scheme and power information acquisition scheme that support PMCH transmission using the MUST technology will be described below with reference to the accompanying drawings and detailed embodiments.

It is to be noted that the present invention shall not be limited to the specific embodiments described below. In addition, detailed descriptions of well-known technologies that are not directly related to the present invention are omitted for the sake of brevity, in order to avoid obscuring the understanding of the present invention.

Multiple embodiments according to the present invention are specifically described in example application environments of an LTE mobile communication system and its subsequent evolved versions. However, it is to be noted that the present invention is not limited to the following embodiments, but may be applied to more other wireless communication systems, such as a future 5G cellular communication system.

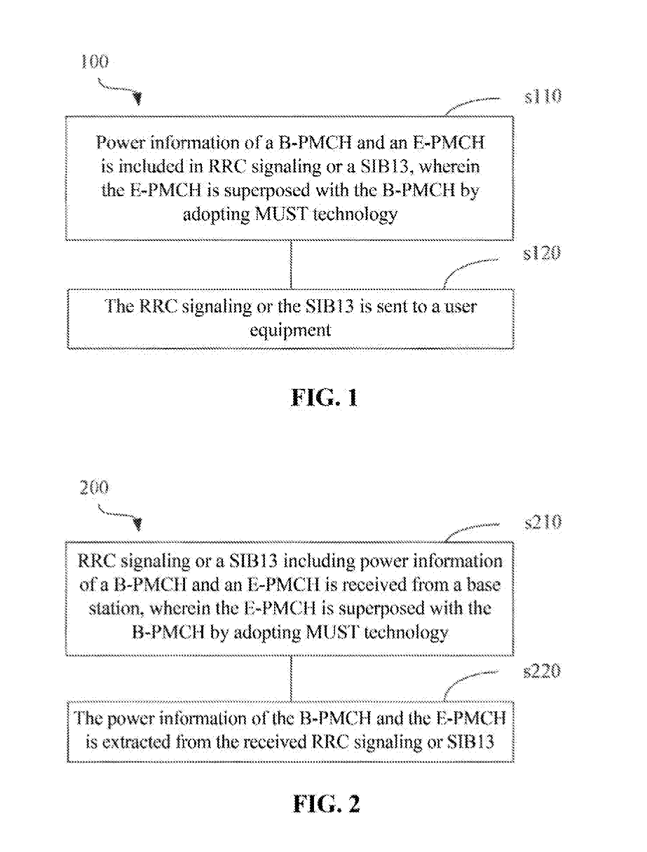

FIG. 1 shows a flowchart illustrating a power information indication method 100 executed by a base station according to an embodiment of the present invention. As shown in the figure, the method comprises the following steps.

Step s110, power information of a B-PMCH and an E-PMCH is included in RRC signaling or a SIB13, wherein the E-PMCH is superposed with the B-PMCH by adopting MUST technology.

As an embodiment, the power information of the B-PMCH and the E-BMCH may be transmitted by the following RRC signaling:

wherein power-indicator-r13 is used to indicate the power information of the B-PMCH and the E-BMCH. Specifically, power-indicator-r13 may indicate a ratio of EPRE of the B-PMCH to EPRE of an RS of an MBMS expressed in dB, e.g.

$$power \text{-} indicator \text{-} r 13 = 10 {log}_{10} \frac{EPRE of a B \text{-} PMCH}{EPRE of an RS of an MBMS}$$

As another embodiment, power-indicator-r13 may indicate a ratio of EPRE of the E-PMCH to EPRE of an RS of an MBMS expressed in dB, e.g.

$$power \text{-} indicator \text{-} r 13 = 10 {log}_{10} \frac{EPRE of a E \text{-} PMCH}{EPRE of an RS of an MBMS}$$

As another embodiment, power-indicator-r13 may indicate a ratio of the EPRE of the B-PMCH to EPRE of an E-RS of an MBMS expressed in dB, e.g.

$$power \text{-} indicator \text{-} r 13 = 10 {log}_{10} \frac{EPRE of a B \text{-} PMCH}{EPRE of an E \text{-} RS of an MBMS}$$

Herein, the E-RS refers to a reference signal designed and used specifically for the E-PMCH.

As another embodiment, power-indicator-r13 may indicate a ratio of EPRE of the E-PMCH to EPRE of an E-RS of an MBMS expressed in dB, e.g.

$$power \text{-} indicator \text{-} r 13 = 10 {log}_{10} \frac{EPRE of a E \text{-} PMCH}{EPRE of an E \text{-} RS of an MBMS}$$

As another embodiment, power-indicator-r13 may indicate a ratio of EPRE of the B-PMCH to EPRE of the E-PMCH expressed in dB, e.g.

$$power \text{-} indicator \text{-} r 13 = 10 {log}_{10} \frac{EPRE of a B \text{-} PMCH}{EPRE of an E \text{-} PMCH}$$

As another embodiment, power-indicator-r13 may indicate a ratio of EPRE of the E-PMCH to EPRE of the B-PMCH expressed in dB, e.g.

$$power \text{-} indicator \text{-} r 13 = 10 {log}_{10} \frac{EPRE of a E \text{-} PMCH}{EPRE of an B \text{-} PMCH}$$

As another embodiment, power-indicator-r13 may indicate a ratio of EPRE of an RE for transmitting an MCCH in the B-PMCH to EPRE of an RS of an MBMS expressed in dB, e.g.

$$power \text{-} indicator \text{-} r 13 = 10 {log}_{10} \frac{EPRE of an MCCH of the B \text{-} PMCH}{EPRE of an RS of the MBMS}$$

As another embodiment, power-indicator-r13 may indicate a ratio of EPRE of an RE for transmitting an MCCH in the E-PMCH to EPRE of an RS of an MBMS expressed in dB, e.g.

$$power \text{-} indicator \text{-} r 13 = 10 {log}_{10} \frac{EPRE of an MCCH of the E \text{-} PMCH}{EPRE of an RS of the MBMS}$$

As another embodiment, power-indicator-r13 may indicate a ratio of EPRE of an R transmitting an MCCH in the B-PMCH to EPRE of an E-RS of an MBMS expressed in dB, e.g.

$$power \text{-} indicator \text{-} r 13 = 10 {log}_{10} \frac{EPRE of an MCCH of the B \text{-} PMCH}{EPRE of an E \text{-} RS of the MBMS}$$

As another embodiment, power-indicator-r13 may indicate a ratio of EPRE of an RE for transmitting an MCCH in the E-PMCH to EPRE of an E-RS of an MBMS expressed in dB, e.g.

$$power \text{-} indicator \text{-} r 13 = 10 {log}_{10} \frac{EPRE of an MCCH of the E \text{-} PMCH}{EPRE of an E \text{-} RS of the MBMS}$$

As another embodiment, power-indicator-r13 may indicate a ratio of EPRE of an RE for transmitting an MTCH in the B-PMCH to EPRE of an RS of an MBMS expressed in dB, e.g.

$$power \text{-} indicator \text{-} r 13 = 10 {log}_{10} \frac{EPRE of an MTCH of the B \text{-} PMCH}{EPRE of an RS of the MBMS}$$

As another embodiment, power-indicator-r13 may indicate a ratio of EPRE of an RE for transmitting an MTCH in the E-PMCH to EPRE of an RS of an MBMS expressed in dB, e.g.

$$power \text{-} indicator \text{-} r 13 = 10 {log}_{10} \frac{EPRE of an MTCH of the E \text{-} PMCH}{EPRE of an RS of the MBMS}$$

As another embodiment, power-indicator-r13 may indicate a ratio of EPRE of an RE for transmitting an MTCH in the B-PMCH to EPRE of an E-RS of an MBMS expressed in dB, e.g.

$$power \text{-} indicator \text{-} r 13 = 10 {log}_{10} \frac{EPRE of an MTCH of the B \text{-} PMCH}{EPRE of an E \text{-} RS of the MBMS}$$

As another embodiment, power-indicator-r13 may indicate a ratio of EPRE of an RE for transmitting an MTCH in the E-PMCH to EPRE of an E-RS of an MBMS expressed in dB, e.g.

$$power \text{-} indicator \text{-} r 13 = 10 {log}_{10} \frac{EPRE of an MTCH of the E \text{-} PMCH}{EPRE of an E \text{-} RS of the MBMS}$$

As another embodiment, the power information of the B-PMCH and the E-BMCH is transmitted by the following RRC signaling:

wherein power-indicator-r13 may indicate a ratio of power of the B-PMCH to the sum of power of the B-PMCH and the E-PMCH.

As another embodiment, power-indicator-r13 may indicate a ratio of power of the E-PMCH to the sum of power of the B-PMCH and the E-PMCH.

As another embodiment, power-indicator-r13 may indicate a ratio of the power of the B-PMCH to the maximum transmit power.

As another embodiment, power-indicator-r13 may indicate a ratio of the power of the E-PMCH to the maximum transmit power.

As another embodiment, the power information of the B-PMCH and the E-BMCH may be any permutations and combinations of the above-described embodiments.

As another embodiment, the power information of the B-PMCH and the E-BMCH may be transmitted by the following RRC signaling:

wherein power-set-indicator-r13 is used to indicate a combination of the power of the B-PMCH and the E-BMCH. Table 1 lists an indication mode of a power combination in which values in second and third columns correspond to ratios of the power of B-BPCH to total power of the B-PMCH and the E-BMCH and ratios of the power of the E-PMCH to the total power of the B-PMCH and the E-BMCH.

TABLE 1

| | Power ratio | Power ratio |
|---|---|---|
| power-set-indicator-r13 | of B-PMCH | of E-PMCH |
| 00 | 0.1 | 0.9 |
| 01 | 0.2 | 0.8 |
| 10 | 0.3 | 0.7 |
| 11 | 0.4 | 0.6 |

When the value of power-set-indicator-r13 is 00, it indicates that the power ratio of the B-PMCH is 0.1, and the power ratio of the E-PMCH is 0.9.

When the value of power-set-indicator-r13 is 01, it indicates that the power ratio of the B-PMCH is 0.2, and the power ratio of the E-PMCH is 0.8.

When the value of power-set-indicator-r13 is 10, it indicates that the power ratio of the B-PMCH is 0.3, and the power ratio of the E-PMCH is 0.7.

When the value of power-set-indicator-r13 is 11, it indicates that the power ratio of the B-PMCH is 0.4, and the power ratio of the E-PMCH is 0.6.

In step s120, the RRC signaling or the SIB13 produced in step s110 is sent to the user equipment.

By executing the above power information indication method 100, the base station can indicate relative power (i.e., power allocation information) of the B-PMCH and the E-PMCH to the user equipment, so as to effectively support PMCH transmission that uses MUST technology.

The present invention further proposes a power information acquisition method 200 executed by a user equipment, which corresponds to the above power information indication method 100 executed by the base station. As shown in FIG. 2, the method 200 comprises the following steps.

Step s210, RRC signaling or a SIB13 including power information of a B-PMCH and an E-PMCH is received from a base station, wherein the E-PMCH is superposed with the B-PMCH by adopting MUST technology.

Step s220, the power information of the B-PMCH and the E-PMCH is extracted from the received RRC signaling or SIB13.

As those skilled in the art will appreciate, the RRC signaling or the SIB13 received by the user equipment from the base station in the method 200 is exactly the RRC signaling or the SIB13 sent by the base station to the user equipment in the method 100.

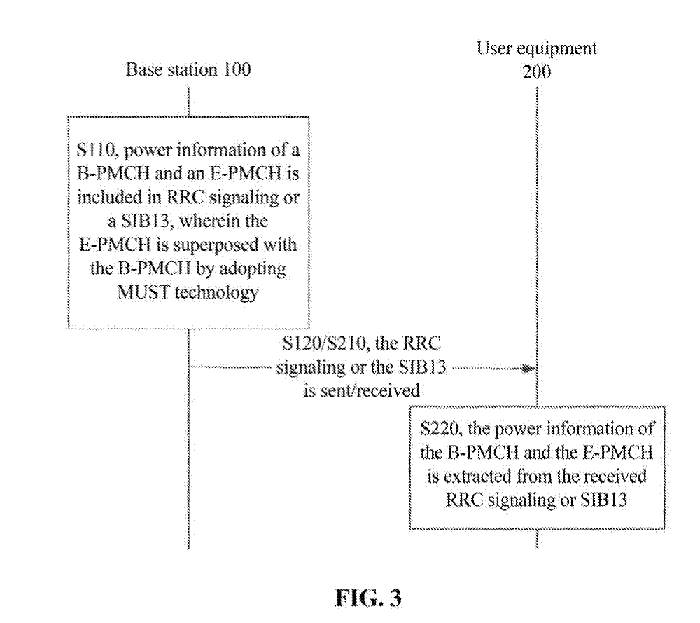

For ease of understanding, FIG. 3 further illustrates a sequence diagram showing respective processing of and signaling interaction between the base station and the user equipment according to an embodiment of the present invention. As shown in the figure, firstly, step s110 in the method 100 is executed at a base station side; and power information of the B-PMCH and the E-PMCH is included in the RRC signaling or the SIB13. Then step s120 in the method 100 is executed to send the RRC signaling or the SIB13 produced in step s110 to the user equipment. Correspondingly, step s210 in the method 200 is executed at a user equipment side to receive the RRC signaling or the SIB13 including the power information of the B-PMCH and the E-PMCH from the base station. Then, step s220 is executed to extract the power information of the B-PMCH and the E-PMCH from the received RRC signaling or SIB13.

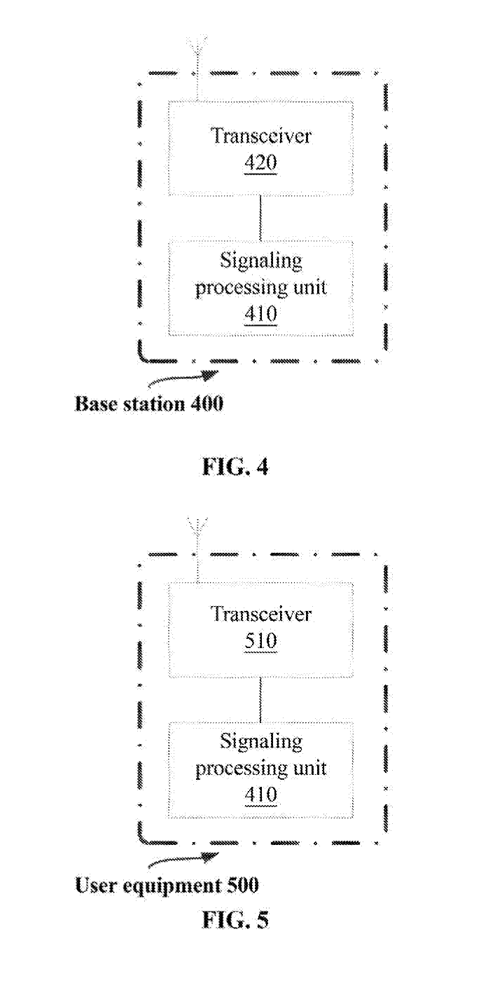

FIGS. 4 and 5 respectively illustrate structural block diagrams of a base station 400 and a user equipment 500 corresponding to the power information indication method executed by the base station and the power information acquisition method executed by the user equipment described with reference to FIGS. 1 and 2.

As shown in FIG. 4, the base station 400 comprises a signaling processing unit 410 and a transceiver 420. The signaling processing unit 410 is used to include the power information of the B-PMCH and the E-PMCH in the RRC signaling or the SIB13. The transceiver 420 is used to send the RRC signaling or the SIB13 to the user equipment.

As shown in FIG. 5, the user equipment 500 includes a transceiver 510 and a signaling processing unit 520. The transceiver 510 is used to receive the RRC signaling or the SIB13 including the power information of the B-PMCH and the E-PMCH from the base station. The signaling processing unit 520 is used to extract the power information of the B-PMCH and the E-PMCH from the received RRC signaling or SIB13.

It is to be understood that the above-described embodiments of the present invention may be implemented by software or by hardware or by a combination of both software and hardware. For example, various components inside the base station and the user equipment in the above-described embodiments may be implemented by various devices, which include but are not limited to: analog circuit devices, digital circuit devices, digital signal processing (DSP) circuits, programmable processors, application specific integrated circuits (ASICs), field programmable gate arrays (FPGAs), programmable logic devices (CPLDs), and the like.

In the present application, a “base station” refers to a mobile communication data and control switching center provided with a larger transmitting power and a wider coverage area and including functions such as resource allocation and scheduling, and data receiving and sending. A “user equipment” refers to a user mobile terminal, for example, a terminal device that can wirelessly communicate with a base station or a micro base station, such as a mobile phone, and a notebook.

In addition, the embodiments of the present invention disclosed herein may be implemented on a computer program product. More specifically, the computer program product is a product having a computer-readable medium having computer program logic encoded thereon that, when executed on a computing device, provides related operations to implement the above-described technical solutions of the present invention. When executed on at least one processor of a computing system, the computer program logic causes the processor to perform the operations (methods) described in the embodiments of the invention. Such an arrangement of the present invention is typically provided as software, codes and/or other data structures disposed on or encoded on a computer-readable medium such as an optical medium (eg, a CD-ROM), a floppy disk or a hard disk, or other media such as firmware or microcode on one or more ROM or RAM or PROM chips, or downloadable software images and shared databases in one or more modules etc. Software or firmware or such configuration may be installed on a computing device, such that one or more processors in the computing device perform the technical solutions described in the embodiments of the present invention.

While the present invention has been illustrated in connection with the preferred embodiments of the present invention, it will be understood by those skilled in the art that various modifications, substitutions, and alterations may be made to the present invention without departing from the spirit and scope of the invention. Therefore, the present invention should not be limited by the above-described embodiments, but should be defined by the appended claims and their equivalents.

1. A power information indication method executed by a base station, comprising:
including power information of a B-PMCH and an E-PMCH in RRC signaling or a SIB 13, wherein the E-PMCH is superposed with the B-PMCH by adopting MUST technology; and
sending the RRC signaling or the SIB13 to a user equipment.

2. The method according to claim 1, wherein the power information may include one or more of the following items indicated by an information element (power-indicator-r13):
a ratio of EPRE of the B-PMCH to EPRE of an RS of an MBMS;
a ratio of EPRE of the E-PMCH to the EPRE of the RS of the MBMS;
a ratio of the EPRE of the B-PMCH to EPRE of an E-RS of the MBMS;
a ratio of the EPRE of the E-PMCH to the EPRE of the E-RS of the MBMS;
a ratio of the EPRE of the B-PMCH to the EPRE of the E-PMCH;
a ratio of the EPRE of the E-PMCH to the EPRE of the B-PMCH;
a ratio of EPRE of an RE for transmitting an MCCH in the B-PMCH to the EPRE of the RS of the MBMS;
a ratio of EPRE of an RE for transmitting the MCCH in the E-PMCH to the EPRE of the RS of the MBMS;
a ratio of the EPRE of the RE for transmitting the MCCH in the B-PMCH to the EPRE of the E-RS of the MBMS;
a ratio of the EPRE of the RE for transmitting the MCCH in the E-PMCH to the EPRE of the E-RS of the MBMS;
a ratio of EPRE of an RE for transmitting an MTCH in the B-PMCH to the EPRE of the RS of the MBMS;
a ratio of EPRE of an RE for transmitting the MTCH in the E-PMCH to the EPRE of the RS of the MBMS;
a ratio of the EPRE of the RE for transmitting the MTCH in the B-PMCH to the EPRE of the E-RS of the MBMS;
a ratio of the EPRE of the RE for transmitting the MTCH in the E-PMCH to the EPRE of the E-RS of the MBMS;
a ratio of power of the B-PMCH to a sum of the power of the B-PMCH and the E-PMCH;
a ratio of power of the E-PMCH to the sum of the power of the B-PMCH and the E-PMCH;
a ratio of the power of the B-PMCH to maximum transmit power; and
a ratio of the power of the E-PMCH to the maximum transmit power.

3. The method according to claim 2, wherein the ratios are expressed in dB.

4. The method according to claim 1, wherein the power information comprises a combination of ratios of the power of the B-PMCH and the power of the E-PMCH, indicated by the information element (power-set-indicator-r13).

5. A base station, comprising:
a signaling processing unit, used to include power information of a B-PMCH and an E-PMCH in RRC signaling or a SIB13, wherein the E-PMCH is superposed with the B-PMCH by adopting MUST technology;
and a transceiver, used to send the RRC signaling or the SIB13 to a user equipment.

6. A power information acquisition method executed by a user equipment, comprising:
receiving RRC signaling or a SIB13 including power information of a B-PMCH and an E-PMCH from a base station, wherein the E-PMCH is superposed with the B-PMCH by adopting MUST technology; and
extracting the power information of the B-PMCH and the E-PMCH from the received RRC signaling or SIB13.

7. A user equipment, comprising:
a transceiver, used to receive RRC signaling or a SIB13 including power information of a B-PMCH and an E-PMCH from a base station, wherein the E-PMCH is superposed with the B-PMCH by adopting MUST technology; and
a signaling processing unit, used to extract the power information of the B-PMCH and the E-PMCH from the received RRC signaling or SIB13.
